(19) United States
(12) Patent Application Publication
(10) Pub. No.: US 2026/0230636 A1
(43) Pub. Date: Aug. 6, 2026

(54) Video Transmission Method, System, Device, and Storage Medium

(71) Applicant: CLOUD INTELLIGENCE ASSETS HOLDING (SINGAPORE) PRIVATE LIMITED, Singapore (SG)

(72) Inventors: Fen LI, Shanghai (CN); Xiantao ZHANG, Hangzhou, Zhejiang (CN); Jinkui REN, Hangzhou, Zhejiang (CN)

(21) Appl. No.: 18/869,008

(22) PCT Filed: May 22, 2023
(86) PCT No.: PCT/CN2023/095451

§ 371 Date: Nov. 25, 2024

(30) Foreign Application Priority Data
May 23, 2022 (CN) 202210563770.1

(51) Int. Cl. H04N 19/176; H04N 19/119; H04N 19/146; H04N 19/172

(52) U.S. Cl. CPC H04N 19/176; H04N 19/119; H04N 19/146; H04N 19/172

(57) ABSTRACT

The present disclosure provides a video transmission method and system, a device, and a storage medium. The method includes that: after obtaining a video frame to be encoded, any video frame in a video to be encoded except the first frame is divided into a first preset number of sub-video frames; each sub-video frame respectively is encoded and sent to a decoding end. Through applying the technical solution of the present disclosure, the encoded video frames are not directly transmitted, but are transmitted in a manner of sub-video frames after being divided, thereby ensuring that the data amount of each transmission object is controlled within a certain range, and further avoiding the problem of picture delay caused by the fact that key frame data cannot be transmitted to a destination end in time for decoding and rendering when the network bandwidth is insufficient.

The present disclosure claims priority of Chinese Patent Application No. 202210563770.1, filed to China Patent Office on May 23, 2022 and titled “Video Transmission Method, System, Device, and Storage Medium”, the content of which is hereby incorporated by reference in its entirety.

### TECHNICAL FIELD

The present disclosure relates to the field of video transmission technologies, and in particular, to a video transmission method, a system, a device, and a storage medium.

### BACKGROUND OF THE INVENTION

The development of network technology and multimedia technology promotes more and more live streaming media applications on the Internet. The transmission proportion of streaming media data in the Internet becomes larger and larger, which brings challenges to the transmission capability of the Internet.

In a live streaming media application, a video stream generally having a certain image quality tends to have a higher requirement for a transmission bandwidth. However, there is often a problem in the related art that communication bandwidth cannot meet streaming media requirements. For example, during video encoding, the encoder generates a key frame (namely I frame) as needed. Since the I frame contains all the decoded information, the data amount of the I frame is usually relatively large, resulting in a relatively large code rate of the data stream generated at this time. It may be understood that, when the network bandwidth is insufficient, frame data cannot be transmitted to a destination end in time for decoding and rendering, thereby generating delay and lag.

### SUMMARY OF THE INVENTION

The present disclosure provides a video transmission method, a system, a device, and a storage medium, to resolve a problem in the related art that, when a network bandwidth is insufficient, key frame data cannot be transmitted to a destination end in time for decoding and rendering, resulting in a picture delay.

An embodiment of the first aspect of present disclosure provides a video transmission method, applied to an encoder, and including that:
a video frame to be encoded is obtained, the video frame to be encoded being any video frame in a video to be encoded except the first frame;
the video frame to be encoded is divided into a first preset number of sub-video frames;
each sub-video frame respectively is encoded to obtain the first preset number of encoded sub-video frames, and the encoded sub-video frames is sent to a decoding end, where the number of key frames in the encoded sub-video frames is less than the first preset number.

An embodiment of the second aspect of present disclosure provides a video transmission method, applied to a decoding end, and including that:
a first preset number of encoded sub-video frames transmitted from a encoding end is obtained, where the number of key frames in the encoded sub-video frames is less than the first preset number;
each encoded sub-video frame is respectively decoded to obtain the first preset number of sub-video frames;
the first preset number of sub-video frames are merged into a target video frame.

An embodiment of the third aspect of present disclosure provides a video transmission system, including:
an encoding end, arranged for obtaining a video frame to be encoded, the video frame to be encoded being any video frame in a video to be encoded except the first frame; dividing the video frame to be encoded into a first preset number of sub-video frames; and encoding each sub-video frame respectively to obtain the first preset number of encoded sub-video frames, and sending the encoded sub-video frames to a decoding end, where the number of key frames in the encoded sub-video frames is less than the first preset number;
the decoding end, arranged for obtaining a first preset number of encoded sub-video frames transmitted from a encoding end; decoding each encoded sub-video frame respectively to obtain the first preset number of sub-video frames; and merging the first preset number of sub-video frames into a target video frame.

An embodiment of a third aspect of present disclosure provides an electronic device, including a memory, a processor, and a computer program stored in the memory and executable on the processor, where the processor is arranged for running the computer program to implement the method according to the first aspect.

An embodiment of a fourth aspect of present disclosure provides a computer-readable storage medium, on which a computer program is stored, where the program is executed by a processor to implement the method according to the first aspect.

The technical solutions provided in the embodiments of present disclosure have at least the following technical effects or advantages.

In some embodiments of present disclosure, after the encoding end obtains the video frame to be encoded, each video frame to be encoded other than the first frame is separately divided to obtain multiple sub-video frames, and the multiple sub-video frames are respectively encoded and transmitted to the decoding end, so that the decoding end decodes the multiple sub-video frames and merges the multiple sub-video frames into a transmission video. Through applying the technical solution of present disclosure, the encoded video frame is not directly transmitted, but is divided and transmitted in a sub-video frame manner. Therefore, it is ensured that the data amount of each transmission object is controlled within a certain range. In addition, in the process of encoding the sub-video frames in some embodiments of present disclosure, it is necessary to ensure that all the sub-video frames in the same original encoded frame are not subjected to key frame encoding, so as to further ensure that the data amount of the encoded sub-video frame transmitted each time is not too large. In this way, the problem that the key frame data cannot be transmitted to the destination end in time for decoding and rendering when the network bandwidth is insufficient is avoided.

Additional aspects and advantages of the present disclosure will be given in part in the following description, and some will become apparent from the following description, or be learned by the practice of the present disclosure.

### BRIEF DESCRIPTION OF DRAWINGS

Various other advantages and benefits will become apparent to those skilled in the art by reading the following detailed description of the optional embodiments. The drawings are for the purpose of illustrating the optional embodiments, and are not considered to be limiting of the present disclosure. Moreover, in the entire drawings, the same reference symbols are used for referring to the same components. In the drawings:

FIG. 1 is a schematic diagram of a video transmission method according to an embodiment of present disclosure.

FIG. 2 is another schematic diagram of a video transmission method according to an embodiment of present disclosure.

FIG. 3 is a flowchart of a video transmission method according to an embodiment of present disclosure.

FIG. 4 is another flowchart of a video transmission method according to an embodiment of present disclosure.

FIG. 5 is a schematic structural diagram of a video transmission apparatus according to an embodiment of present disclosure.

FIG. 6 is a schematic structural diagram of another video transmission apparatus according to an embodiment of present disclosure.

FIG. 7 is a schematic structural diagram of an electronic device according to an embodiment of present disclosure.

FIG. 8 is a schematic diagram of a storage medium according to an embodiment of present disclosure.

### DETAILED DESCRIPTION OF THE INVENTION

Exemplary implementations of the present disclosure will be described in more detail below with reference to the accompanying drawings. Although exemplary embodiments of the present disclosure are shown in the accompanying drawings, it should be understood that the present disclosure may be implemented in various forms and should not be limited by the embodiments set forth herein. Rather, these embodiments are provided to enable a more thorough understanding of the present disclosure, and to fully convey the scope of the present disclosure to those skilled in the art.

It should be noted that, unless otherwise stated, the technical terms or scientific terms used in some embodiments the present disclosure should be common meanings understood by those skilled in the art to which present disclosure belongs.

The following describes a video transmission method, a system, a device, and a storage medium according to some embodiments of present disclosure with reference to the accompanying drawings.

Embodiments of present disclosure provide a video transmission method, where after obtaining a video frame to be encoded, the encoding end separately divides each video frame to be encoded other than the first frame to obtain multiple sub-video frames, and encodes each of the sub-video frames and transmits the encoded sub-video frames to a decoding end, so that the decoding end decodes the multiple sub-video frames and then combines the multiple sub-video frames into a transmission video.

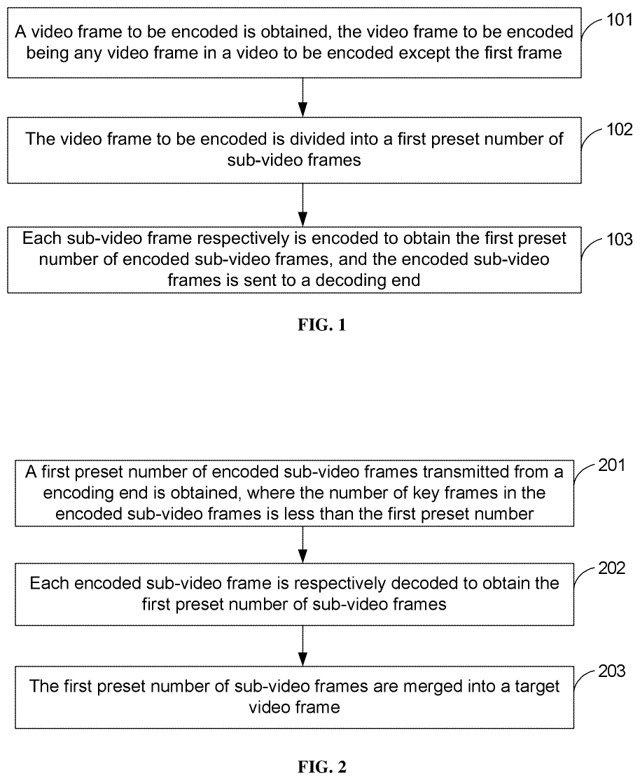

As shown in FIG. 1, the method is applied to an encoding end, and includes the following steps.

In step 101, a video frame to be encoded is obtained, the video frame to be encoded being any video frame in a video to be encoded except the first frame.

With the rapid development of the Internet and the increasingly mature multimedia technology, the market application of video communication becomes more and more extensive, and the manner of implementing video communication becomes diverse, such as videophone, instant messaging, video chat, network television, Internet Protocol Television (IPTV), remote control, remote medical treatment, etc.

The basis for implementing video communication is efficient video coding and decoding and coding frame transmission. Currently mainstream video compression standards include Moving Picture Experts Group 4 (MPEG4), H264, and the like. In these compression technologies, an encoded image is generally classified into three types, including a key frame (namely I frame) and an inter-frame frame (namely P frame) and a bidirectional frame (namely B frame) in a non-key frame.

Further, the key frame (namely I frame) is a video frame which utilizes spatial correlation and encodes still images in a manner similar to Joint Photographic Experts Group (JPEG). The key frame is independently decoded without reference to information of other frames. Therefore, when the video is accessed, a start frame is the key frame. In addition, in order to prevent interruption caused by network packet loss in a video communication process, the key frame is inserted at intervals in the continuous video stream, so that the purpose of recovering the video transmission after packet loss can be achieved.

In addition, a non-key frame (such as P frame), utilizes time correlation and sets a previous frame of this P frame as a reference frame for prediction. The non-key frame (such as B frame) sets both a previous frame of this B frame and a following frame of this B frame as the reference frames for prediction. Residual data is generated After the prediction, Discrete Cosine Transform (DCT) transformation and quantization are performed on the residual data to output an encoded code stream to complete the video compression process.

In a manner, since the key frame includes all information for decoding, no reference to other images is required. And usually, the code rate of the data stream generated at this time is relatively large. It may be understood that, when the network transmission bandwidth is unchanged, a time period required for transmitting the I frame to the destination end is longer. And when the network bandwidth is insufficient, key frame data cannot be transmitted to the destination end in time for decoding and rendering, thereby generating a delay and lag problem. In step 102, the video frame to be encoded is divided into a first preset number of sub-video frames.

In view of the above problem, the some embodiments of the present disclosure provides a technical solution for dividing a video frame into multiple sub-video frames according to a preset dividing strategy before sending a video frame to an encoder, and respectively sending the sub-video frames to an encoder for encoding, so as to transmit and decode the video data after obtaining the multiple encoded sub-video frames, and combine the sub-video frame portions for rendering after decoding.

In one manner, the present disclosure does not limit how to divide a video frame to be encoded. For example, one video frame is uniformly divided into a certain number of sub-video frames (for example, evenly divided into two, three or four sub-video frames, etc.), or objects with different brightness, different images or different resolutions are divided according to image data carried on the video frame.

Similarly, a first preset number is not limited in some embodiments of present disclosure. In a manner, the first preset number of different partitions is selected along with a size of a data amount of a video frame or a current network transmission quality.

In step 103, each sub-video frame respectively is encoded to obtain the first preset number of encoded sub-video frames, and the encoded sub-video frames is sent to a decoding end, where the number of key frames in the encoded sub-video frames is less than the first preset number. In a manner, after dividing the video frame to be encoded to obtain the first preset number of sub-video frames, each sub-video in the first preset number of sub-video frames is required to be separately sent to the video encoder to obtain the first preset number of encoded sub-video frames.

It should be noted that, after the video frame to be encoded that originally is required to be input to the key frame decoder is divided into multiple sub-video frames, the embodiments of present disclosure do not send all the multiple sub-video frames to a key frame decoder. That is, the first preset number of sub-video frames, in which the first preset number is reduced, is sent to the key frame decoder. Therefore, it is avoided that all the sub-video frames are encoded into key frames, and the subsequent transmission of multiple key sub-video frames still faces a problem of large transmission pressure.

For example, in some embodiments of present disclosure, for example, a video frame to be encoded A that originally is required to be input to a key frame decoder is divided into three sub-video frames (respectively, a sub-video frame A, a sub-video frame B, and a sub-video frame C). It may be understood that the present disclosure, at least one of the three sub-video frames and at most no more than two sub-video frames are inputted into the key frame decoder (for example, inputting the sub-video frame A and the sub-video frame B into the key frame encoder). In this case, other sub-video frames (i.e. the sub-video frame c) is inputted to the non-key frame encoder.

In one manner, after obtaining the first preset number of encoded sub-video frames, some embodiments of present disclosure send at least one encoded sub-video frame to the decoding end.

In some embodiments of present disclosure, after the encoding end obtains the video frame to be encoded, each video frame to be encoded other than the first frame is separately divided to obtain multiple sub-video frames, and the multiple sub-video frames are respectively encoded and transmitted to the decoding end, so that the decoding end decodes the multiple sub-video frames and merges the multiple sub-video frames into a transmission video. Through applying the technical solution of present disclosure, the encoded video frame is not directly transmitted, but is divided and transmitted in a sub-video frame manner. Therefore, it is ensured that the data amount of each transmission object is controlled within a certain range. In addition, in the process of encoding the sub-video frames in some embodiments of present disclosure, it is necessary to ensure that all the sub-video frames in the same original encoded frame are not subjected to key frame encoding, so as to further ensure that the data amount of the encoded sub-video frame transmitted each time remains weak. In this way, the problem that the key frame data cannot be transmitted to the destination end in time for decoding and rendering when the network bandwidth is insufficient is avoided.

Optionally, in some embodiments of present disclosure, in a process of encoding each sub-video frame separately, the following steps are performed.

A first data amount and a second data amount corresponding to the video frame to be encoded is determined, where the first data amount is a data amount for encoding the video frame to be encoded as a key frame, and the second data amount is a data amount for encoding the video frame to be encoded as a non-key frame.

A frame type of the video frame to be encoded is determined based on the first data amount and the second data amount.

Each sub-video frame respectively is encoded according to the frame type.

In a possible manner, in the technical solution of present disclosure, a coding frame type of each video frame to be encoded is first determined. That is, it is determined that each video frame to be encoded is encoded as a key frame or a non-key frame. As an example, in the sub-video frames obtained by dividing the video frame to be encoded into a key frame, a portion of the sub-video frames are encoded into key sub-video frames. In sub-video frames obtained by dividing the video frame to be encoded into a non-key frame, all sub-video frames in the sub-video frame are encoded into non-key sub-video frames.

In a possible manner, in some embodiments of present disclosure, a manner, in which it is determined that each video frame to be encoded is encoded as the key frame or the non-key frame, is determined based on a data amount for encoding the video frame to be encoded as the key frame and the non-key frame. For example, with respect to an data amount of the video frame to be encoded after being encoded as the non-key frame, if an data amount of the video frame to be encoded after being encoded as the key frame is large, a frame type of the video frame to be encoded is the non-key frame. Otherwise, a frame type of the video frame to be encoded is the key frame.

In a possible manner, for example, it is determined that the frame type of the video frame to be encoded is the non-key frame when a first data amount (that is, the data amount for encoding this video frame as the key frame) of the video frame to be encoded is greater than or equal to a second data amount (that is, the data amount for encoding this video frame as non-key frame).

In another possible manner, for example, it is determined that the frame type of the video frame to be encoded is the key frame when the first data amount (that is, the data amount for encoding the sub video frame as the key frame) of the video frame to be encoded is less than the second data amount (that is, the data amount for encoding the sub video frame as the non-key frame).

A manner of how to determine a size relationship between the first data amount and the second data amount of the video frame to be encoded is not limited in some embodiments the present disclosure. For example, a difference operation is performed on the first data amount and the second data amount. That is, after a result of the difference operation meets a certain value, the size relationship between the first data amount and the second data amount is determined. Alternatively, a ratio operation is performed on the first data amount and the second data amount. That is, after a result of the ratio operation meets another certain value, the size relationship between the first data amount and the second data amount is determined.

In another possible manner, the size relationship between the first data amount and the second data amount not only meets the foregoing condition, but also further achieves other conditions (for example, the first data amount is greater than the certain value, or the first data amount is less than the certain value, or the second data amount is greater than the certain value, or the second data amount is less than the certain value) to determine the frame type corresponding to the first data amount and the second data amount.

Optionally, in some embodiments of present disclosure, the following two cases are included in a process of encoding each sub-video frame based on a frame type.

In the first case, when the frame type of the video frame to be encoded is the key frame, a target sub-video frame that is encoded as the key frame is determined from each sub-video frame. The number of the target sub-video frame is at least one, and the number of the target sub-video frame is less than a first preset number.

The target sub-video frame is encoded into the key frame, and the sub-video frames except the target sub-video frame in each sub-video frame are encoded into non-key frames.

For a case that the frame type of the video frame to be encoded is the key frame, in some embodiments the present disclosure, at least one and not all of the sub-video frames is determined from the multiple sub-video frames obtained by splitting the encoded frame as the target sub-video frame. The target sub-video frame is encoded into the key frame, and the other sub-video frames are encoded as non-key frames.

In a possible manner, in some embodiments the present disclosure, in a process of determining at least one and not all of the sub-video frames from the multiple sub-video frames as the target sub-video frame, the following steps are implemented.

A third data amount corresponding to each sub-video frame is calculated, where the third data amount is a data amount of the sub-video frame encoded as the key frame.

A second preset number of sub-video frames with the smallest third data amount is determined as the target sub-video frame which is encoded as the key frame, and the second preset data amount is greater than or equal to one and less than the first preset number.

In a possible manner, in some embodiments of present disclosure, a manner for determining that each sub-video frame is encoded as the key frame or the non-key frame is determined based on a data amount for encoding the sub video frame as the key frame and the non-key frame. As an example, when the data amount for encoding the sub video frame as the key frame is relatively large (relative to the data amount for encoding the sub video frame as the non-key frame), the sub-video frame is determined as the target sub-video frame which is encoded as the key frame.

In a possible manner, for example, after determining the third data amount (that is, the data amount for encoding the sub-video frame as the key frame) of each sub-video frame, at least one (but not all) sub-video frame with the smallest data amount is selected as the target sub-video frame.

In another possible manner, for example, the smallest one of the third data amount (that is, the data amount for encoding the video frame as the key frame) of the multiple sub-video frames is determined as the target sub-video frame.

The following are example explanations of the video transmission method provided in some embodiments the present disclosure.

For example, in some embodiments of present disclosure, first, a video frame to be encoded A (any video frame except the first frame) is obtained. The video frame to be encoded A is divided into three sub-video frames (respectively, a sub-video frame A, a sub-video frame B, and a sub-video frame C) according to a preset dividing principle.

Further, a data amount A1 for encoding the video frame to be encoded A into a key frame is calculated. A data amount A2 for encoding the video frame to be encoded A into a non-key frame is calculated as an example. When the A1 is greater than or equal to A2, it is determined that the frame type of the video frame to be encoded A is the non-key frame. In another example, when the A1 is less than A2, it is determined that the frame type of the video frame to be encoded A is the key frame.

In a possible embodiment, when the frame type of the video frame to be encoded A is the key frame, the sub-video frame a obtained from the video frame to be encoded is encoded as a data amount a1 of the key frames, the sub-video frame b is encoded as a data amount b1 of the key frames, and the sub-video frame c is encoded as the data amount c1 of the key frames.

As an example, through comparing the size relationship of a1, b1, and c1, the sub-video frame a with the smallest data amount is selected as the key frame to obtain the first key sub-frame. The sub-video frame b and the sub-video frame c are encoded into non-key frames to obtain the first non-key sub-frame.

It may be understood that the first key sub-frame and the first non-key sub-frame are sent to the decoding end, so that the decoding end decodes each coded sub-video frame to obtain three sub-video frames, and then the three sub-video frames are merged into the target video frame.

In another possible embodiment, when the frame type of the video frame to be encoded A is a non-key frame, the sub-video frame a, the sub-video frame b, and the sub-video frame c are directly encoded as non-key frames, and then sent to the decoding end, so that the decoding end decodes each encoded sub-video frame to obtain three sub-video frames, and then the three sub-video frames are merged into the target video frame.

Optionally, after dividing the video frame to be encoded into the first preset number of sub-video frames, the following steps are further included.

A sequence number mark is sequentially added to each sub-video frame, where the sequence number mark is used for guiding the decoding end to merge the sub-video frames.

In some embodiments of present disclosure, after the encoding end divides the video frame to be encoded into the first preset number of sub-video frames, in order to avoid that the subsequent decoding end can smoothly merge the sub-video frames to obtain the target video frame. In some embodiments of present disclosure, the sequence number mark is sequentially added to each sub-video frame in the video frame to be encoded by the encoder, so as to avoid a problem that the decoding end cannot sequentially merge the sub-video frames in the subsequent transmission process due to the fact that the arrival sequence of the sub-video frames is disordered due to unstable network bandwidth.

The sequence number mark is composed of numbers, or composed of letters or other fields. This is not limited in some embodiments the present disclosure.

Optionally, in some embodiments of present disclosure, an operation of dividing the video frame to be encoded into the first preset number of sub-video frames to be encoded includes the following steps.

A data amount of a video frame to be encoded is determined.

When the data amount is greater than a preset data amount, the video frame to be encoded is divided into a first number of sub-video frames to be encoded.

When the data amount is not greater than the preset data amount, the video frame to be encoded is divided into a second number of sub-video frames to be encoded, where the second number is less than the first number.

In a manner, in some embodiments the present disclosure, in a manner of dividing the video frame to be encoded, for example, one video frame is uniformly divided into a certain number of sub-video frames (for example, evenly divided into two, three or four sub-video frames), or different numbers of sub-video frames are divided according to the data size of the video frame.

It may be understood that, the data amount carried by the video frame to be encoded is greater, and the number of sub-video frames divided by the video frame to be encoded is further more.

Optionally, before obtaining the video frame to be encoded in some embodiments of present disclosure, the method further includes the following steps.

Key frame encoding is performed on the first video frame in a video to be encoded to obtain a target key frame.

The target key frame is sent to the decoding end.

In one manner, since the key frame (namely I frame) is a video frame that makes use of spatial correlation and encodes a still image in a manner similar to JPEG. The key frame is independently decoded without reference to the information of other frames. Therefore, the start frame is the key frame during video access. In some embodiments of present disclosure, after determining that the video frame to be encoded obtained this time is the first frame in the video to be encoded, the video frame to be encoded is not divided but the key frame encoding is directly performed on the video frame to be encoded, and the target key frame is sent to the decoding end after obtaining the target key frame.

As shown in FIG. 2, the method is applied to a decoding end, and specifically includes the following steps.

In step 201, a first preset number of encoded sub-video frames transmitted from a encoding end is obtained, where the number of key frames in the encoded sub-video frames is less than the first preset number.

In one manner, the decoding end receives multiple encoded sub-video frames sent by an encoding end in some embodiments of present disclosure. The encoded sub-video frame is obtained after the encoding end divides an original video frame to be encoded into multiple sub-video frames according to a preset dividing strategy, and then encodes each sub-video frame.

In some embodiments of present disclosure, a manner of how to divide the video frame to be encoded is not limited in some embodiments of present disclosure. For example, one video frame is uniformly divided into a certain number of sub-video frames (for example, evenly divided into two, three or four sub-video frames, etc.), or objects with different brightness, different images or different resolutions is divided according to the image data carried on the video frame.

Similarly, the first preset number is not limited in some embodiments of present disclosure. In a manner, the first preset number of different partitions is selected along with a size of a data amount of a video frame or a current network transmission quality.

In step 202, each encoded sub-video frame is respectively decoded to obtain the first preset number of sub-video frames.

In view of the problems existing in the related art, the present disclosure provides a technical solution for dividing a video frame into multiple sub-video frames according to the preset dividing strategy before sending the video frame to the encoder, and respectively sending the sub-video frames to the encoder for encoding, so as to transmit and decode the video data after obtaining the multiple encoded sub-video frames, and combine sub-video frame portions for rendering after decoding.

In step 203, the first preset number of sub-video frames are merged into a target video frame.

In an optional manner, the encoding end combines the first preset number of sub-video frames into the target video frame in sequence according to a receiving order of each received encoded sub-video frame.

In another embodiment, the encoding end further extracts the sequence number mark carried by each encoded sub-video frame, and combines the first preset number of sub-video frames into the target video frame in sequence according to the sequence of the sequence number marks.

Through applying the technical solution of present disclosure, the encoded video frame is not directly transmitted, but is divided and transmitted in a sub-video frame manner. Therefore, it is ensured that the data amount of each transmission object is controlled within a certain range. In addition, in the process of encoding the sub-video frames in some embodiments of present disclosure, it is necessary to ensure that all the sub-video frames in the same original encoded frame are not subjected to key frame encoding, so as to further ensure that the data amount of the encoded sub-video frame transmitted each time remains weak. In this way, the problem that the key frame data cannot be transmitted to the destination end in time for decoding and rendering when the network bandwidth is insufficient is avoided.

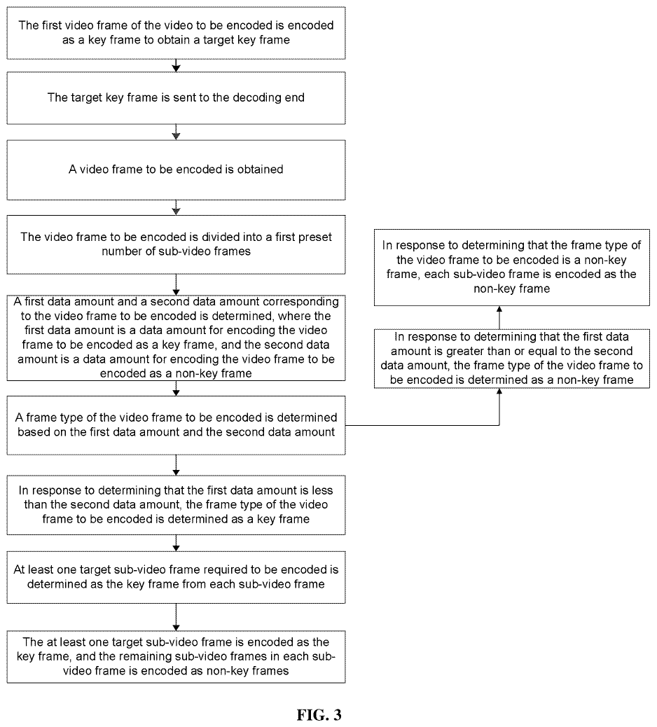

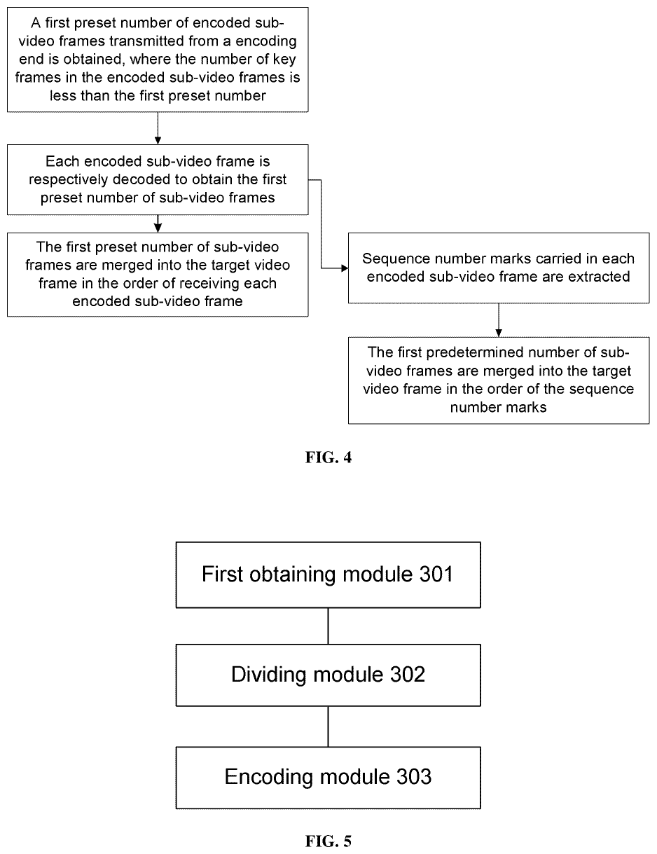

As shown in FIG. 3 to FIG. 4, it is a schematic flowchart of a video transmission method according to present disclosure, including the following steps.

As shown in FIG. 3, a video transmission method is implemented by an encoding end, and the method includes the following steps. A video frame to be encoded is obtained. The video frame to be encoded is divided into a first preset number of sub-video frames, each sub-video frame to is encoded to obtain the first preset number of encoded sub-video frames, and the encoded sub-video frames are sent to a decoding end.

The video frame to be encoded is any video frame other than the first frame in the video to be encoded, and the number of key frames in the encoded sub-video frame is less than the first preset number.

As shown in FIG. 4, a video transmission method is implemented by a decoding end, and the method includes the following steps.

A first preset number of encoded sub-video frames transmitted by an encoding end is obtained. Each encoded sub-video frame is respectively decoded to obtain the first preset number of sub-video frames, and the first preset number of sub-video frames are combined into a target video frame.

The number of key frames in the encoded sub-video frame is less than the first preset number.

Some embodiments of present disclosure further provide a video transmission system, arranged for performing operations performed by an encoding end and a decoding end in the video transmission method provided in any one of the foregoing embodiments. The system includes:
an encoding end, arranged for obtaining a video frame to be encoded, the video frame to be encoded being any video frame in a video to be encoded except the first frame; dividing the video frame to be encoded into a first preset number of sub-video frames; and encoding each sub-video frame respectively to obtain the first preset number of encoded sub-video frames, and sending the encoded sub-video frames to a decoding end, where the number of key frames in the encoded sub-video frames is less than the first preset number;
the decoding end, arranged for obtaining a first preset number of encoded sub-video frames transmitted from a encoding end; decoding each encoded sub-video frame respectively to obtain the first preset number of sub-video frames; and merging the first preset number of sub-video frames into a target video frame.

For the same inventive concept, the video transmission apparatus provided in the foregoing embodiments of present disclosure has the same beneficial effects as those used, run, or implemented by the application program stored in the video transmission apparatus according to the embodiments of present disclosure.

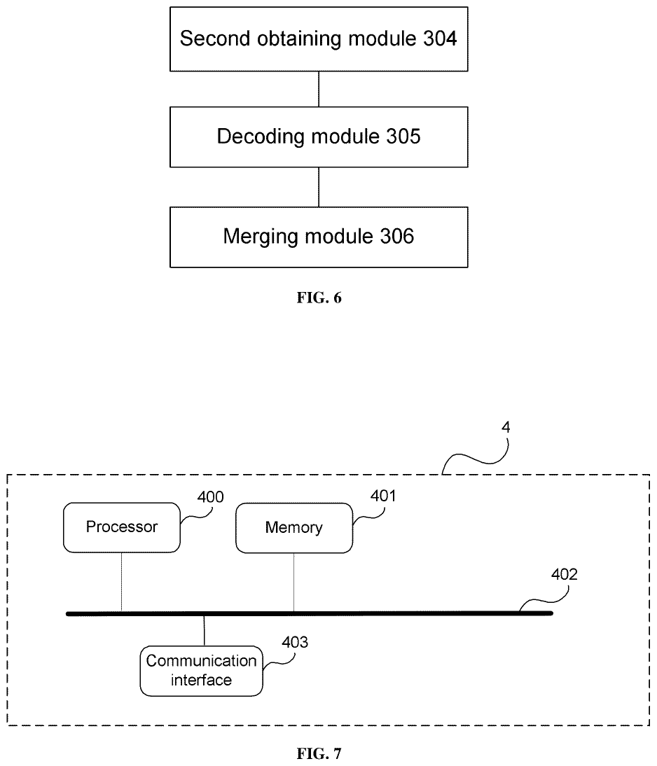

Some embodiments of present disclosure further provide a video transmission apparatus, arranged for performing an operation performed by an encoding end in the video transmission method provided in any one of the foregoing embodiments. As shown in FIG. 5, the apparatus includes:
a first obtaining module 301, arranged for obtaining a video frame to be encoded, the video frame to be encoded being any video frame in a video to be encoded except the first frame;
a dividing module 302, arranged for dividing the video frame to be encoded into a first preset number of sub-video frames; and
an encoding module 303, arranged for encoding each sub-video frame respectively to obtain the first preset number of encoded sub-video frames, and sending the encoded sub-video frames to a decoding end, where the number of key frames in the encoded sub-video frames is less than the first preset number.

The encoding module 303 is further arranged for determining a first data amount and a second data amount corresponding to the video frame to be encoded, where the first data amount is a data amount for encoding the video frame to be encoded as a key frame, and the second data amount is a data amount for encoding the video frame to be encoded as a non-key frame; and determining a frame type of the video frame to be encoded based on the first data amount and the second data amount; and encoding each sub-video frame respectively according to the frame type.

The encoding module 303 is further arranged for, in response to determining that the first data amount is greater than or equal to the second data amount, determining the frame type of the video frame to be encoded as a non-key frame; and in response to determining that the first data amount is less than the second data amount, determining the frame type of the video frame to be encoded as a key frame.

The encoding module 303 is further arranged for, in response to determining that the frame type of the video frame to be encoded is the key frame, determining at least one target sub-video frame required to be encoded as the key frame from each sub-video frame, the number of the at least one target sub-video frame being less than the first preset number; encoding the at least one target sub-video frame as the key frame, and encoding the remaining sub-video frames in each sub-video frame as non-key frames; or, in response to determining that the frame type of the video frame to be encoded is a non-key frame, encoding each sub-video frame as the non-key frame.

The encoding module 303 is further arranged for calculating a third data amount corresponding to each sub-video frame respectively, where the third data amount is a data amount for encoding the sub-video frame as the key frame; and determining the second preset number of sub-video frames with the smallest third data amount as the at least one target sub-video frame required to be encoded as the key frame, where the second preset number is greater than or equal to 1 and the second preset number is less than the first preset number.

The dividing module 302 is arranged for adding a sequence number mark to each sub-video frame in turn, the sequence number mark being used for guiding the decoding end to merge the sub-video frames.

The dividing module 302 is arranged for determining a data amount of the video frame to be encoded; in response to the data amount being greater than a preset data amount, dividing the video frame to be encoded into a first number of sub-video frames to be encoded; and in response to the data amount being not greater than the preset data amount, dividing the video frame to be encoded into a second number of sub-video frames to be encoded, where the second number is less than the first number.

The first obtaining module 301 is arranged for encoding the first video frame of the video to be encoded as a key frame to obtain a target key frame; and sending the target key frame to the decoding end.

Some embodiments of present disclosure further provide a video transmission apparatus, arranged for performing an operation performed by a decoding end in the video transmission method provided in any one of the foregoing embodiments. As shown in FIG. 6, the apparatus includes:
a second obtaining module 304, arranged for obtaining a first preset number of encoded sub-video frames transmitted from a encoding end, where the number of key frames in the encoded sub-video frames is less than the first preset number;
a decoding module 305, arranged for decoding each encoded sub-video frame respectively to obtain the first preset number of sub-video frames; and
a merging module 306, arranged for merging the first preset number of sub-video frames into a target video frame.

The merging module 306 is arranged for merging the first preset number of sub-video frames into the target video frame in the order of receiving each encoded sub-video frame.

The merging module 306 is arranged for extracting sequence number marks carried in each encoded sub-video frame; and merging the first predetermined number of sub-video frames into the target video frame in the order of the sequence number marks.

For the same inventive concept, the video transmission apparatus provided in the foregoing embodiments of present disclosure has the same beneficial effects as those used, run, or implemented by the application program stored in the video transmission apparatus according to the embodiments of present disclosure.

Some embodiments of present disclosure further provide an electronic device, to perform the foregoing video transmission method. FIG. 7 is a schematic diagram of an electronic device according to some implementations of present disclosure. As shown in FIG. 7, the electronic device 4 includes: a processor 400, a memory 401, a bus 402, and a communication interface 403. The processor 400, the communication interface 403, and the memory 401 are connected by using a bus 402. The memory 401 is arranged for storing a computer program executable on the processor 400. The processor 400 is arranged for executing the computer program to perform the video transmission method provided in any one of the foregoing implementations of present disclosure.

The memory 401 includes a high-speed random access memory (RAM), or further includes a non-transitory memory, for example, at least one magnetic disk memory. The communication connection between an apparatus network element and at least one other network element is implemented by using at least one communication interface 403 (which is wired or wireless), and uses the Internet, a wide area network, a local network, a metropolitan area network, and the like.

The bus 402 is an instruction Set Architecture (ISA) bus, a Peripheral Component Interconnect (PCI) bus, a Extended Industry Standard Architecture (EISA) bus, or the like. The bus is classified into an address bus, a data bus, a control bus, and the like. The memory 401 is arranged for storing a program, and after receiving the execution instruction, the processor 400 is arranged for executing the program, and the video transmission method disclosed in any embodiment of the foregoing embodiments of present disclosure is applied to the processor 400 or implemented by the processor 400.

The processor 400 is an integrated circuit chip, and has a signal processing capability. In an implementation process, steps of the foregoing method are completed by using an integrated logic circuit of hardware in the processor 400 or an instruction in a form of software. The processor 400 is a general-purpose processor, including a central processing unit (CPU), a network processor (NP), or the like, or may be a digital signal processor (DSP), an application specific integrated circuit (ASIC), a field programmable gate array (FPGA), another programmable logic device, a discrete gate or transistor logic device, or a discrete hardware component. The processor implements or performs the methods, steps, and logical block diagrams disclosed in the embodiments of present disclosure. The general-purpose processor is a microprocessor, or the processor is any conventional processor or the like. The steps of the methods disclosed with reference to the embodiments of present disclosure are directly performed and completed by a hardware decoding processor, or are performed and completed by using a combination of hardware and software modules in a decoding processor. The software module is located in a mature storage medium in the art, such as a random access memory, a flash memory, a read-only memory, a programmable read-only memory, an electrically erasable programmable memory, or a register. The storage medium is located in the memory 401, and the processor 400 is arranged for reading information in the memory 401 and completing the steps of the foregoing method in combination with hardware of the processor 400.

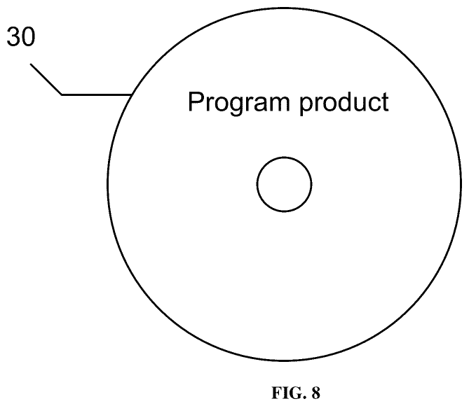

For the same inventive concept, the electronic device provided in some embodiments of present disclosure has the same beneficial effects as the method adopted, run or implemented by using the video transmission method provided in the embodiments of present disclosure. Some embodiments of present disclosure further provide a computer-readable storage medium corresponding to the video transmission method provided in the foregoing implementations. As shown in FIG. 8, the computer-readable storage medium shown in FIG. 8 is an optical disk 30, and a computer program (i.e. a program product) is stored on the optical disk 30. When the computer program is run by the processor, the video transmission method provided in any of the foregoing implementations is performed.

It should be noted that, examples of the computer-readable storage medium further include, but are not limited to, a phase change memory (PRAM), a static random access memory (SRAM), a dynamic random access memory (DRAM), another type of random access memory (RAM), a read-only memory (ROM), an electrically erasable programmable read-only memory (EEPROM), a flash memory or other optical and magnetic storage media, and details are not described herein again.

For the same inventive concept, the computer-readable storage medium provided in the foregoing embodiments of present disclosure has the same beneficial effects as those used, run, or implemented by the application program stored therein for the same inventive concept.

It should be noted that, in the specification provided herein, numerous specific details are set forth. However, it can be understood that the embodiments of present disclosure may be practiced without these specific details. In some instances, well-known structures and techniques are not shown in detail in order not to obscure the understanding of this specification.

Similarly, it should be understood that, in order to simplify the present disclosure and help understand at least one of the aspects of the present disclosure, in the description of the exemplary embodiments of the present disclosure, various features of the present disclosure are sometimes grouped together into a single embodiment, a figure, or a description thereof. This method of the present disclosure, however, should not be interpreted as reflecting a schematic diagram that the claimed subject application requires more features than are expressly recited in each claim. Rather, as the following claims reflect, inventive aspects lie in less than all features of a single embodiment disclosed above. Therefore, the claims following the Detailed Description are hereby expressly incorporated into this Detailed Description, with each claim standing on its own as a separate embodiment of the present disclosure.

In addition, those skilled in the art can understand that although some embodiments described herein include certain features included in other embodiments rather than other features, combinations of features of different embodiments are intended to be within the scope of present disclosure and form different embodiments. For example, in the following claims, any one of the claimed embodiments is used in any combination.

The above are exemplary embodiments of the present disclosure, but the scope of protection of the present disclosure is not limited thereto, and any changes or substitutions that can be easily conceived of by those skilled in the art within the technical scope disclosed in the present disclosure should be covered within the scope of protection of the present disclosure. Therefore, the protection scope of present disclosure shall be subject to the protection scope of the claims.

1. A video transmission method, wherein the method is applied to an encoding end, and the method comprises:
obtaining a video frame to be encoded, the video frame to be encoded being any video frame in a video to be encoded except the first frame;
dividing the video frame to be encoded into a first preset number of sub-video frames;
encoding each sub-video frame respectively to obtain the first preset number of encoded sub-video frames, and sending the encoded sub-video frames to a decoding end, wherein the number of key frames in the encoded sub-video frames is less than the first preset number.

2. The method as claimed in claim 1, wherein encoding each sub-video frame respectively comprises:
determining a first data amount and a second data amount corresponding to the video frame to be encoded, wherein the first data amount is a data amount for encoding the video frame to be encoded as a key frame, and the second data amount is a data amount for encoding the video frame to be encoded as a non-key frame;
determining a frame type of the video frame to be encoded based on the first data amount and the second data amount;
encoding each sub-video frame respectively according to the frame type.

3. The method as claimed in claim 2, wherein determining the frame type of the video frame to be encoded based on the first data amount and the second data amount comprises:
in response to determining that the first data amount is greater than or equal to the second data amount, determining the frame type of the video frame to be encoded as a non-key frame;
in response to determining that the first data amount is less than the second data amount, determining the frame type of the video frame to be encoded as a key frame.

4. The method as claimed in claim 2, wherein encoding each sub-video frame respectively according to the frame type comprises:
in response to determining that the frame type of the video frame to be encoded is the key frame, determining at least one target sub-video frame required to be encoded as the key frame from each sub-video frame, the number of the at least one target sub-video frame being less than the first preset number;
encoding the at least one target sub-video frame as the key frame, and encoding the remaining sub-video frames in each sub-video frame as non-key frames.

5. The method as claimed in claim 4, wherein determining the at least one target sub-video frame required to be encoded as the key frame from each sub-video frame comprises:
calculating a third data amount corresponding to each sub-video frame respectively, wherein the third data amount is a data amount for encoding the sub-video frame as the key frame;
determining the second preset number of sub-video frames with the smallest third data amount as the at least one target sub-video frame required to be encoded as the key frame, wherein the second preset number is greater than or equal to 1 and the second preset number is less than the first preset number.

6. The method as claimed in claim 1, wherein after dividing the video frame to be encoded into the first preset number of sub-video frames, the method further comprises:
adding a sequence number mark to each sub-video frame in turn, the sequence number mark being used for guiding the decoding end to merge the sub-video frames.

7. The method as claimed in claim 1, wherein dividing the video frame to be encoded into the first preset number of sub-video frames to be encoded comprises:
determining a data amount of the video frame to be encoded;
in response to the data amount being greater than a preset data amount, dividing the video frame to be encoded into a first number of sub-video frames to be encoded;
in response to the data amount being not greater than the preset data amount, dividing the video frame to be encoded into a second number of sub-video frames to be encoded, wherein the second number is less than the first number.

8. The method as claimed in claim 1, wherein before obtaining the video frame to be encoded, the method further comprises:
encoding the first video frame of the video to be encoded as a key frame to obtain a target key frame;
sending the target key frame to the decoding end.

9. A video transmission method, wherein the method is applied to a decoding end, and the method comprises:
obtaining a first preset number of encoded sub-video frames transmitted from a encoding end, wherein the number of key frames in the encoded sub-video frames is less than the first preset number;
decoding each encoded sub-video frame respectively to obtain the first preset number of sub-video frames;
merging the first preset number of sub-video frames into a target video frame.

10. The method as claimed in claim 9, wherein merging the first preset number of sub-video frames into the target video frame comprises:
merging the first preset number of sub-video frames into the target video frame in the order of receiving each encoded sub-video frame.

11. The method as claimed in claim 9, wherein merging the first preset number of sub-video frames into the target video frame comprises:
extracting sequence number marks carried in each encoded sub-video frame;
merging the first predetermined number of sub-video frames into the target video frame in the order of the sequence number marks.

12. A video transmission system, comprising:
an encoding end, arranged for obtaining a video frame to be encoded, the video frame to be encoded being any video frame in a video to be encoded except the first frame; dividing the video frame to be encoded into a first preset number of sub-video frames; and encoding each sub-video frame respectively to obtain the first preset number of encoded sub-video frames, and sending the encoded sub-video frames to a decoding end, wherein the number of key frames in the encoded sub-video frames is less than the first preset number;
the decoding end, arranged for obtaining a first preset number of encoded sub-video frames transmitted from a encoding end; decoding each encoded sub-video frame respectively to obtain the first preset number of sub-video frames; and merging the first preset number of sub-video frames into a target video frame.

13. (canceled)

14. (canceled)

15. The method as claimed in claim 1, wherein the maximum value of the first data amount is the first predetermined number minus one.

16. The method as claimed in claim 3, wherein the method further comprises:
comparing the first data amount with the second data amount in response to at least one of the first data amount and the second data amount satisfying a preset numerical condition.

17. The method as claimed in claim 2, wherein encoding each sub-video frame separately according to the frame type comprises:
in response to determining that the frame type of the video frame to be encoded is a non-key frame, encoding each sub-video frame as the non-key frame.

18. The method as claimed in claim 1, wherein dividing the video frame to be encoded into the first predetermined number of sub-video frames comprises:
dividing the video frame to be encoded evenly into the first predetermined number of sub-video frames.

19. The method as claimed in claim 1, wherein dividing the video frame to be encoded into the first predetermined number of sub-video frames comprises:
dividing objects of different brightness, different image or different resolution of image data carried in the video frame to be encoded into the first predetermined number of sub-video frames.

20. The method as claimed in claim 9, wherein the encoded sub-video frames are obtained by the encoding end dividing the original video frame to be encoded into multiple sub-video frames according to preset division rules, and then encoding each sub-video frame separately.
